(19) United States
(12) Patent Application Publication
(10) Pub. No.: US 2018/0209374 A1
(43) Pub. Date: Jul. 26, 2018

(54) SYSTEM AND METHOD FOR POSITIONING AN INSERT IN AN ENGINE

(71) Applicant: Kuryakyn Holdings, LLC, Somerset, WI (US)

(72) Inventors: Thomas Michael Kilgriff, Scandia, MN (US); Joel Allen Knauber, New Richmond, WI (US)

(21) Appl. No.: 15/415,994

(22) Filed: Jan. 26, 2017

(51) Int. Cl. F02F 1/06; F02B 61/02

(52) U.S. Cl. CPC F02F 1/065; F02F 2200/00; F02B 61/02

(57) ABSTRACT

An apparatus is provided including an insert for an engine. The insert includes an elongated body sized to be positioned in an opening defined in the engine. The elongated body extends along a longitudinal axis from an upper end to a lower end. A fin extends outwardly from the elongated body. A flange extends outwardly from at least one of the fin and the elongated body. A locking mechanism is coupled to the elongated body and is moveable along the longitudinal axis between a first position in which the locking mechanism is positioned in the elongated body and a second position in which the locking mechanism extends outwardly from the lower end of the elongated body.

### BACKGROUND

The present disclosure relates to an insert for an engine and, more specifically, to designs for an insert and a method for positioning the insert in the engine.

### TECHNICAL FIELD

Motorcycles include an engine that enables combustion to power an output of the engine. Generally, the engine includes a piston positioned within a combustion chamber and coupled to a camshaft. Combustion within the engine drives the piston to actuate the camshaft, such that the camshaft produces a power output for the vehicle. A spark plug is positioned within the engine to deliver an electric current from an ignition system of the motorcycle to the combustion chamber. In the combustion chamber, the spark plug ignites a compressed fuel/air mixture by an electric spark, thereby providing the combustion necessary to drive the piston.

The spark plug typically includes an electrode that produces a spark from the electric current within the combustion chamber. The electrode is positioned within the combustion chamber and electrically wired to the ignition system. To wire the electrode to the ignition system, a portion of the spark plug extends from the combustion chamber to carry the wiring to the ignition system. This portion of the spark plug is insulated to prevent electric shock to a rider. Generally, the insulated portion of the spark plug and the subsequent wiring is visible when viewing the motorcycle.

### SUMMARY

According to one aspect of the disclosure, an apparatus includes an insert for an engine having an elongated body sized to be positioned in an opening defined in the engine. The elongated body extends along a longitudinal axis from an upper end to a lower end. A fin extends outwardly from the elongated body. A flange extends outwardly from at least one of the fin and the elongated body. A locking mechanism is coupled to the elongated body. The locking mechanism is moveable along the longitudinal axis between a first position in which the locking mechanism is positioned in the elongated body and a second position in which the locking mechanism extends outwardly from the lower end of the elongated body.

In some embodiments, the insert includes a bore extending from the upper end to the lower end. The locking mechanism is positioned in the bore. The locking mechanism includes a threaded shaft positioned within the bore and operable to move a plug from the first position to the second position. The bore includes an opening at the upper end of the elongated body. The threaded shaft is accessible through the opening.

In some embodiments, the fin includes side surfaces. The fin has a wedge shape such that the side surfaces angle away from the elongated body. In some embodiments, the fin includes an attachment body extending along a bottom surface thereof. The flange extends outwardly from the attachment body. In some embodiments, a plurality of fins extends outwardly from the elongated body. A fin proximal to the lower end of the elongated body is wider than a fin proximal to the upper end of the elongated body. In some embodiments, the elongated body includes an inner surface extending from the lower end to the upper end. The fin defines a passageway along the inner surface.

In some embodiments, the apparatus includes an engine having an opening defined by a surface and a sidewall. The insert is positioned within the opening of the engine. In some embodiments, the engine includes a fin defining part of the sidewall of the opening. When the locking mechanism is in the second position and the insert is positioned in the opening, the locking mechanism applies a first force in a first direction to the surface of the engine and the flange of the insert applies a second force in a second direction to the fin of the engine. The first direction is opposite the second direction.

According to another aspect, an insert for an engine includes an elongated body sized to be positioned in an opening defined in the engine. The elongated body extends along a longitudinal axis from an upper end to a lower end. The elongated body has an inner surface and an outer surface. A fin extends outwardly from the outer surface of the elongated body. A flange extends outwardly from the fin. A locking mechanism is coupled to the elongated body. The locking mechanism is moveable along the longitudinal axis between a first position in which the locking mechanism is positioned in the elongated body and a second position in which the locking mechanism extends outwardly from the lower end of the elongated body.

According to yet another aspect, a method includes aligning an insert with an opening defined in an engine. The method also includes advancing the insert into the opening to position a flange of the insert below a fin of the engine. The method also includes actuating a moveable locking mechanism of the insert to advance the locking mechanism in a first direction to apply a first force to a surface of the engine and move the flange of the insert in a second direction to apply a second force to the fin of the engine, wherein the first direction is opposite the second direction.

In some embodiments, the method includes operating a threaded shaft to move the moveable locking mechanism of the insert in the first direction. In some embodiments, actuating the moveable locking mechanism includes moving a plurality of flanges of the insert in the second direction to apply a plurality of second forces to a plurality of fins of the engine, wherein a sum of the magnitude of the plurality of second forces being equal to the magnitude of the first force. In some embodiments, advancing the insert into the opening to position a flange of the insert below a fin of the engine includes positioning the flange of the insert in a slot of the engine.

### BRIEF DESCRIPTION OF THE DRAWINGS

The foregoing and other features of the various embodiments of the methods and apparatuses described herein will become more apparent from the following detailed description and the accompanying drawings in which:

FIG. 1 is an elevation view of a vehicle embodied as a motorcycle;

FIG. 2 is a perspective view of an engine of the vehicle shown in FIG. 1 having an insert formed in accordance with an embodiment positioned therein;

FIG. 3 is a perspective view similar to the view of FIG. 2, wherein the insert is removed from the engine;

FIG. 4 is an exploded elevation view of the insert shown in FIG. 2;

FIG. 5 is a perspective view of the insert shown in FIG. 2;

FIG. 6 is another elevation view of the insert shown in FIG. 2;

FIG. 7 is a plan view of the insert shown in FIG. 2;

FIG. 8 is another perspective view of the insert shown in FIG. 2;

FIG. 9 is a cross-sectional view of the insert taken along line D-D shown in FIG. 5;

FIG. 10 is a perspective view of an engine of an another vehicle having an insert formed in accordance with another embodiment positioned therein;

FIG. 11 is a perspective view of the insert shown in FIG. 10;

FIG. 12 is another perspective view of the insert shown in FIG. 10;

FIG. 13 is a plan view of the insert shown in FIG. 10;

FIG. 14 is a perspective view of an engine of an another vehicle having an insert formed in accordance with yet another embodiment positioned therein;

FIG. 15 is a perspective view of the insert shown in FIG. 14;

FIG. 16 is another perspective view of the insert shown in FIG. 14;

FIG. 17 is a plan view of the insert shown in FIG. 14;

FIG. 18 is a perspective view of an engine of an another vehicle having an insert formed in accordance with yet another embodiment positioned therein;

FIG. 19 is a perspective view of the insert shown in FIG. 18;

FIG. 20 is a plan view of the insert shown in FIG. 18; and

FIG. 21 is another plan view of the insert shown in FIG. 18.

### DETAILED DESCRIPTION OF THE DRAWINGS

While the concepts of the present disclosure are susceptible to various modifications and alternative forms, specific exemplary embodiments thereof have been illustrated by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

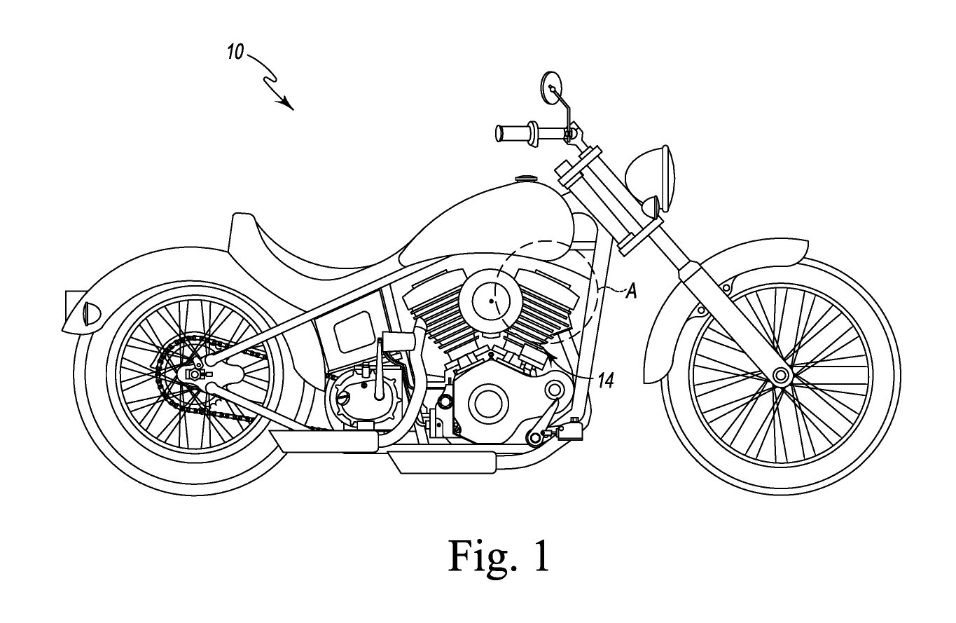

FIG. 1 illustrates a vehicle 10 embodied as a motorcycle. Although FIG. 1 illustrates a motorcycle, the embodiments described herein may be utilized with various other vehicles, for example an all-terrain vehicle, a scooter, a moped, or certain types of automobiles having exposed engine parts. The vehicle 10 includes an engine 14 configured to enable combustion to power an output of the engine 12. Generally, the engine 14 includes a piston (not shown) positioned within a combustion chamber (not shown) and coupled to a camshaft (not shown). Combustion within the engine 14 drives the piston to actuate the camshaft, such that the camshaft produces a power output for the vehicle 10.

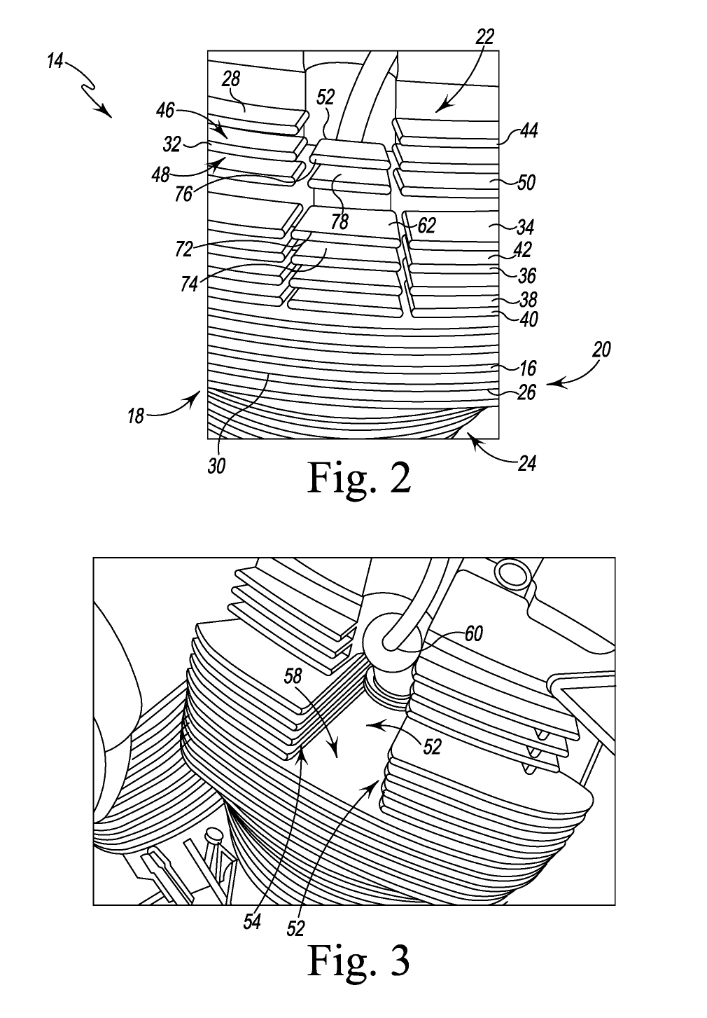

Referring to FIG. 2, the engine 14 includes a body 16 having a first side 18 and a second side 20, and a top 22 and a bottom 24. The body 16 also includes lower body 26 extending from the bottom 24 and an upper body 28 extending from the lower body 26 to the top 22. The lower body 26 includes a lower front face 30 extending between the first side 18 and the second side 20. The upper body 28 includes an upper front face 32 extending between the first side 18 and the second side 20. The lower front face 30 and the upper front face 32 may be decorative and/or include designs thereon. The upper front face 32 is positioned inward from the lower front face 30 defining a step 34 between the lower front face 30 and the upper front face 32. The step 34 divides the lower body 26 from the upper body 28.

The lower body 26 includes a plurality of cooling fins 36 extending between the first side 18 and the second side 20. Each fin 36 includes a top flange surface 38 and a bottom flange surface 40. The fins 36 include a decorative finish thereon. Cooling slots 42 extend between adjacent fins 36 from the first side 18 to the second side 20. The cooling slots 42 are defined between the top flange surface 38 of a fin 36 and the bottom flange surface 38 of an adjacent fin 36. The cooling slots 42 enable airflow therethrough to cool the engine 14. Additionally, the cooling slots 42 enable heat to discharge from the engine 14.

The upper body 28 includes a plurality of cooling fins 44 extending between the first side 18 and the second side 20. Each fin 44 includes a top flange surface 46 and a bottom flange surface 48. The fins 44 include a decorative finish thereon. Cooling slots 50 extend between adjacent fins 44 from the first side 18 to the second side 20. The cooling slots 50 are defined between the top flange surface 46 of a fin 44 and the bottom flange surface 48 of an adjacent fin 44. The cooling slots 50 enable airflow therethrough to cool the engine 14. Additionally, the cooling slots 50 enable heat to discharge from the engine 14.

Referring to FIG. 3, an opening 52 is formed in the body 16 and is defined between a first sidewall 54, a second sidewall 56, and engine surface 58 at a bottom of the opening 52. In the illustrated embodiment, the opening 52 is formed in a cylinder head of the engine 14. A top of the opening 52 extends through the top 22 of the engine 14. The opening 52 is formed in the upper body 28 and part of the lower body 26. The first sidewall 54 and the second sidewall 56 extend between the top 22 and bottom 24 of the body 16 through the upper body 28 and part of the lower body 26. The fins 44 and cooling slots 50 extend from the first side 18 to the first sidewall 54 of the opening 52, and from the second side 20 to the second sidewall 56 of the opening 52. At least some of the fins 36 and cooling slots 42 extend from the first side 18 to the first sidewall 54 of the opening 52, and from the second side 20 to the second sidewall 56 of the opening 52. Other fins 36 and cooling slots 42 extend from the first side 18 to the second side 20 below the opening 52. The engine surface 58 is formed on the lower body 26.

A spark plug 60 extends outward from a bore (not shown) extending through the engine surface 58 and into the opening 52. The spark plug 60 delivers an electric current from an ignition system (not shown) of the vehicle 10 to the combustion chamber of the engine 14. In the combustion chamber, the spark plug 60 ignites a compressed fuel/air mixture by an electric spark, while containing combustion pressure within the engine. The spark plug 60 has a metal threaded shell, electrically isolated from a central electrode by an insulator. The metal shell is screwed into the engine 14 and thus electrically grounded. An insulated top end 61 of the spark plug 60 extends outward from the engine surface 58.

Referring back to FIG. 2, an insert 62 is positioned within the opening 52 to cover the spark plug 60 from view. The insert 62 is positioned above the engine surface 58 and extends between the first sidewall 54 and the second sidewall 56 of the opening 52.

The insert 62 includes a plurality of fins 72 extending between the first sidewall 54 and the second sidewall 56 of the opening 52. The fins 72 include a decorative finish thereon. In one embodiment, the fins 72 are finished to match the decorative features of the fins 36 of the lower body 26 of the engine 14. The insert 62 is positioned within the opening 52 such that the fins 72 of the insert 62 align with the fins 36 of the engine 14. Slots 74 extend between adjacent fins 72 between the first sidewall 54 and the second sidewall 56 of the opening 52. The insert 62 is positioned within the opening 52 such that the slots 74 align with the cooling slots 42 of the engine 14.

The insert 62 includes a plurality of fins 76 extending between the first sidewall 54 and the second sidewall 56 of the opening 52. The fins 76 include a decorative finish thereon. In one embodiment, the fins 76 are finished to match the decorative features of the fins 44 of the upper body 28 of the engine 14. The insert 62 is positioned within the opening 52 such that the fins 76 of the insert 62 align with the fins 44 of the engine 14. Slots 78 extend between adjacent fins 76 between the first sidewall 54 and the second sidewall 56 of the opening 52. The insert 62 is positioned within the opening 52 such that the slots 78 align with the cooling slots 50 of the engine 14.

Although the embodiments described herein are described with respect to having fins 72 and fins 76 that match the features of the fins 36 and fins 44 of the engine 14, one of ordinary skill in the art would appreciate that the insert 62 may have any decorative features that match the decorative features of the engine 14. It will also be appreciated that, in some embodiments, the decorative features of the insert 62 may not match the decorative features of the engine 14.

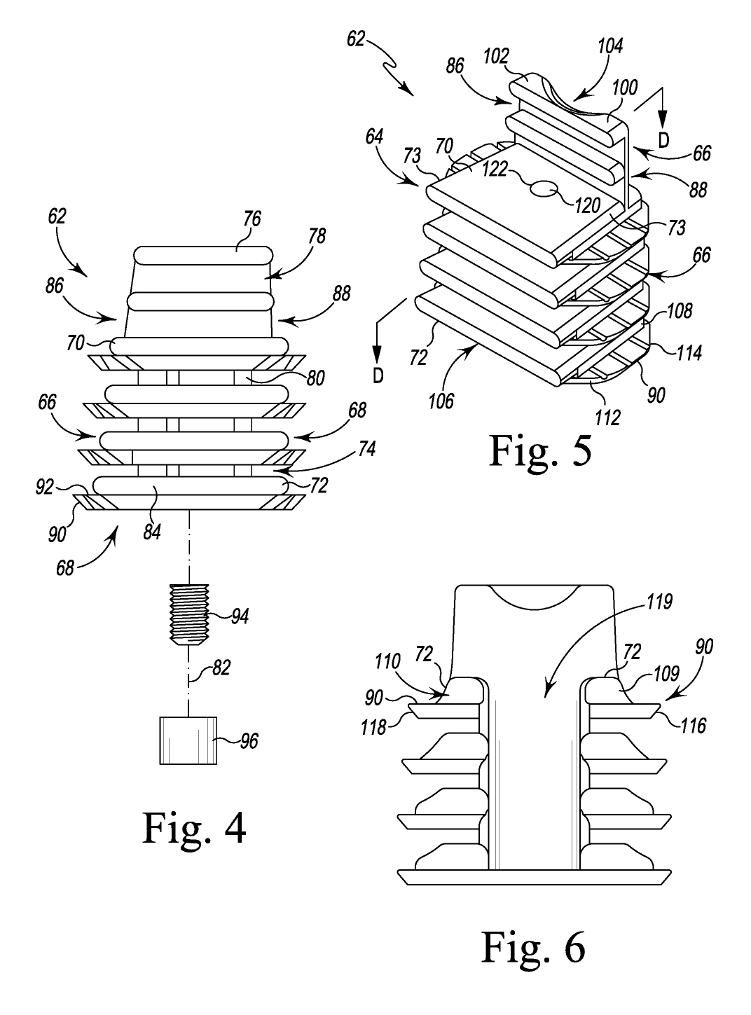

Referring the FIG. 4, the insert 62 includes an elongated body 80 having a longitudinal axis 82 extending from a lower end 68 to an upper end 70. The elongated body 80 includes a first side 64 and a second side 66. FIG. 4 illustrates an outer surface 84 of the insert 62. The elongated body 80 is sized to position within a part of the opening 52 formed in the lower body 26 of the engine 14 and extends from adjacent the engine surface 58 to the step 34 formed in the engine 14.

An upper body 66 extends from the upper end 70 of the elongated body 80. The upper body 66 has a first side 86 and second side 88, which extend beyond the first side 64 and the second side 66, respectively, of the elongated body 80. That is, the upper body 66 is wider than the elongated body 80. In the illustrated embodiment, the second side 66 extends substantially perpendicular to the upper end 70 of the elongated body 80. The first side 64 tapers inward toward the longitudinal axis 82 as the upper body 66 extends outward from the upper end 70 of the elongated body 80. The fins 76 and the slots 78 extend across a front face 86 of the upper body 66 between the first side 86 and the second side 88 of the upper body 66. In the illustrated embodiment, the upper body 66 includes two fins 76. A first of the fins 76 positioned proximally to the elongated body 80 is wider than a second of the fins 76 positioned distally from the elongated body 80. The upper body 66 is sized to position within the part of the opening 52 formed by the upper body 28 of the engine 14 and extends from the step 34 to adjacent the top 22 of the engine 14.

Fins 72 extend outwardly from the elongated body 80 beyond the first side 64 and the second side 66 of the elongated body 80 such that the fins 72 are wider than the elongated body 80. The fins 72 also extend outwardly from the elongated body 80 beyond the first side 86 and the second side 88 of the upper body 66 such that the fins 72 are wider than upper body 66 and the fins 76. As illustrated in FIG. 4, the fins 72 become progressively wider from the upper end 70 to the lower end 68. Particularly, the fin 72 positioned at the lower end 68 is wider than the next adjacent fin 72 when moving toward the upper end 70 of elongated body 80. Each subsequent fin 72 becomes narrower when moving from the lower end 68 to the upper end 70. In one embodiment, each fin 72 extends a substantially equal distance from the elongated body 80 along the second side 66 of the elongated body 80, and each fin 72 progressively extends further from the elongated body 80 along the first side 64 of the elongated body 80 when moving from the upper end 70 to the lower end 68 of the elongated body 80.

The fins 72 include an attachment body 98 extending below and coupled to a bottom of each fin 72. The attachment body 98 has a width that is substantially equal to a width of the respective fin 72. The attachment body 98 extends outwardly from the outer surface 84 of the elongated body 80. In the illustrated embodiment, the respective fin 72 extends from the outer surface 84 of the elongated body 80 further than the respective attachment body 98.

A flange 90 extends outwardly from the respective attachment body 98 of the respective fin 72. In the illustrated embodiment, each flange 90 is substantially parallel to the fin 72 from which the flange 90 extends. In another embodiment, the flanges 90 are not parallel to the fins 72. The flanges 90 also extend from the elongated body 80. Each flange 90 extends from both the first side 64 and the second side 66 of the elongated body 80 beyond the respective fin 72 such that each flange 90 is wider than the respective fin 72. Each flange 90 includes at least one flange surface 92 defined on a part of the flange 90 that extends beyond the respective fin 72.

As seen in FIG. 4, the insert 62 also includes a threaded shaft 94. In one embodiment, the threaded shaft 94 may be any locking mechanism that is threaded or not threaded. In the illustrated embodiment, the insert 62 includes a plug 96. In another embodiment, the insert 62 does not include the plug 96. In such an embodiment, the insert 62 may include a longer threaded shaft 94. The threaded shaft 94 and the plug 96 are actuated along the longitudinal axis 82 of the elongated body 80, as described in more detail below, to secure the insert 62 within the opening 52 of the engine 12.

Referring to FIG. 5, the insert 62 includes an inner surface 100. The fins 72 are tapered in a wedge shaped from the inner surface 100 to beyond the outer surface 84 of the elongated body 80. That is the fins 72 include angled sidewalls 73 that are angled with respect to the inner surface 100 of the elongated body 80. Particularly, the angled sidewalls 73 angle outward from the first side 64 and the second side 66 of the elongated body 80 as the fins 72 extend from inner surface 100 to beyond the outer surface 84 of the elongated body 80.

The upper body 66 of the insert 62 extends upward from the upper end 70 of the elongated body 80 proximate to the inner surface 100 of the elongated body 80. In the illustrated embodiment, the upper body 66 extends parallel to the inner surface 100 of the elongated body 80. In another embodiment, the upper body 66 does not extend parallel to the inner surface 100 of the elongated body 80. A top 102 of the upper body 66 includes an indent 104 formed therein. The indent 104 is centered in the top 102 of the upper body 66 between the first side 86 and the second side 88 of the upper body 66. In one embodiment, the upper body 66 may not include an indent 104. Alternatively, the indent 104 may not be centered between the first side 86 and the second side 88. The indent 104 may provide a surface to grip the insert 62 when positioning the insert 62 within the opening 52 of the engine 14 and/or when removing the insert 62 from the opening 52.

The fins 72 extend beyond the outer surface 84 and inner surface 100 of the elongated body 80. Particularly, the fins 72 include a front surface 106 and a back end 108. The entire front surface 106, which may include decorative features, extends outwardly from the outer surface 84 of the elongated body 80. As seen in FIG. 6, the back end 108 of each fin 72 includes a first side 109 and a second side 110. The first side 109 extends from the inner surface 100 of the elongated body 80 proximate to the first side 64 of the elongated body 80. The second side 110 extends from the inner surface 100 of the elongated body 80 proximate to the second side 66 of the elongated body 80.

Referring back to FIG. 5, the flanges 90 extend outwardly from the outer surface 84 and inner surface 100 of the elongated body 80. Particularly, the flanges 90 include a front end 112 and a back end 114. The entire front end 112 extends outwardly from the outer surface 84 of the elongated body 80. The front surface 106 of the respective fin 72 extends past the front end 112 of the flanges 90. As seen in FIG. 6, the back end 114 of each flange 90 includes a first side 116 and a second side 118. The first side 116 extends from the inner surface 100 of the elongated body 80 proximate to the first side 64 of the elongated body 80. The second side 118 extends from the inner surface 100 of the elongated body 80 proximate to the second side 66 of the elongated body 80. A passageway 119 is formed along the inner surface 100 of the elongated body 80 between the back ends 108 of the fins 72 and the back ends 114 of the flanges 90. The passageway 119 provides a space for the spark plug 60 such that the insert 62 may be positioned adjacent the spark plug 60.

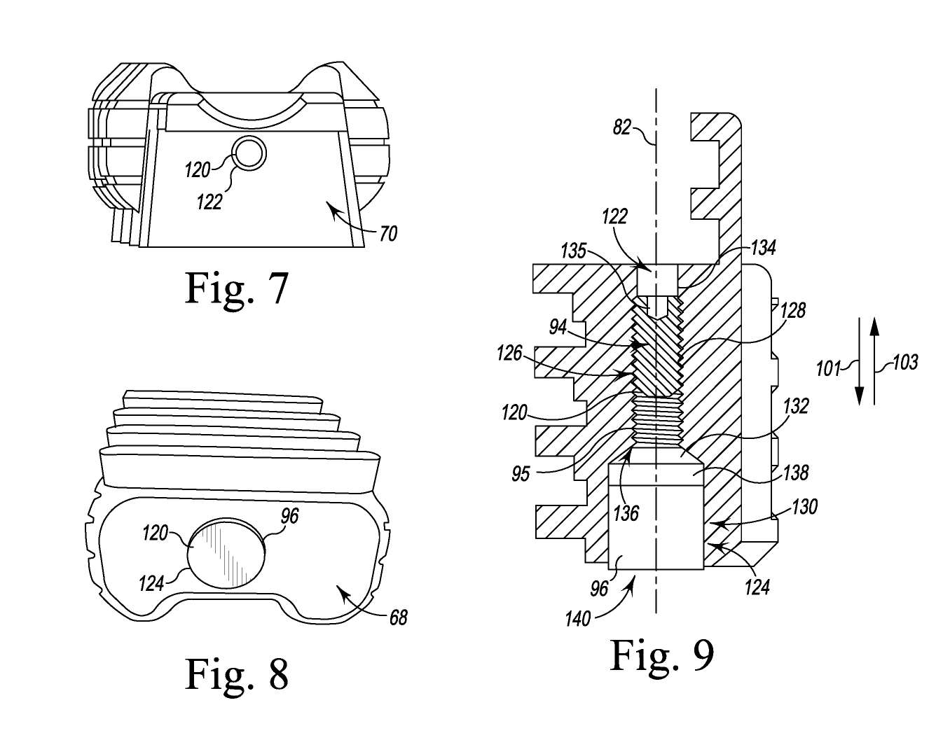

Referring back to FIG. 5, a bore 120 is formed in the elongated body 80. The bore 120 includes an upper end 122 formed through the upper end 70 of the elongated body 80, as further illustrated in FIG. 7. The bore 120 also includes a lower end 124 formed through the lower end 68 of the elongated body 80, as further illustrated in FIG. 8. Notably, FIG. 8 also illustrates the plug 96 positioned at the lower end 68 of the bore 120.

Referring to FIG. 9, the bore 120 includes a passageway 126 formed between the upper end 122 and the lower end 124 of the bore 120. In the illustrated embodiment, the passageway 126 extends parallel to the longitudinal axis 82 of the elongated body 80. In an alternative embodiment, the passageway 126 does not extend parallel to the longitudinal axis 82 of the elongated body 80. The passageway 126 includes an upper passageway 128 and a lower passageway 130. When viewed in cross-section, the lower passageway 130 has a greater width than the upper passageway 128. Tapered walls 132 transition the bore 120 from the upper passageway 128 to the lower passageway 130.

The threaded shaft 94 is positioned within the upper passageway 128. The threaded shaft 94 is threaded to mate with threading 95 in the upper passageway 128 such that the threaded shaft 94 can be screwed through the upper passageway 128 in a first direction, as indicated by arrow 101, and a second direction, as indicated by arrow 103. The threaded shaft 94 includes a top 134 and a bottom 136. The top 134 includes an indent 135 to receive a tool, for example a screwdriver or an Allen wrench.

The plug 96 is positioned within the lower passageway 130. The plug 96 includes a top 138 and a bottom 140. The plug 96 is illustrated in a first position, wherein the plug 96 is positioned within the lower passageway 130. When the threaded shaft 94 is actuated in the direction of arrow 101, the bottom 136 of the threaded shaft 94 engages the top 138 of the plug 96 to move the plug 96 in the direction of arrow 101 into a second position, wherein the bottom 140 of the plug 96 extends outward from the lower end 68 of the elongated body 80. The threaded shaft 94 may be actuated in the direction of arrow 103 to facilitate moving the plug 96 back into the first position.

In operation, the insert 62 is aligned with the opening 52 defined in the engine 14. The insert 62 is then advanced into the opening 52 to position the flanges 90 of the insert 62 below the fins 36 of the engine 14. Particularly, the flanges 90 are positioned within the cooling slots 42 of the engine 14. The threaded shaft 94 of the insert 62 is then operated with a tool to advance the plug 96 in the first direction of arrow 101 such that the plug 96 extends outward from the lower end 68 of the elongated body 80. The plug 96 applies a first force in the first direction of arrow 101 to the engine surface 58, thereby moving the elongated body 80 of the insert 62 in the second direction of arrow 103. In an embodiment that does not include a plug 96, a longer threaded shaft 94 may be actuated in the first direction of arrow 101 such that the bottom 136 of the threaded shaft 94 engages the engine surface 58 to move the insert 62 in the second direction of arrow 103. As the elongated body 80 moves in the second direction of arrow 103, the flanges 90 of the insert 62 apply a second force in the second direction of arrow 103 to the bottom flange surface 38 of the fins 36 of the engine 14. Particularly, the flange surfaces 92 of the flanges 90 of the insert 62 apply the second force to the bottom flange surface 38 of the fins 36 of the engine 14. In one embodiment, a plurality of flanges 90 apply a plurality of second forces to a plurality of fins 36. A sum of the magnitude of the plurality of second forces equals the magnitude of the first force.

The first force and the second force operate to retain the insert 62 within the opening 52. To remove the insert 62 from the opening 52, the treaded shaft 94 may be operated in the second direction of arrow 103, thereby removing force from the threaded shaft 94 to the plug 96. Alternatively, the threaded shaft 94 is disengaged from the engine surface 58. The insert 62 may then be pushed downward toward the engine surface 58 such that the plug 96 moves back to the first position within the elongated body 80 and the flanges 90 disengage the fins 36 of the engine 14, thereby enabling the insert to be removed from the opening 52 in the engine 14.

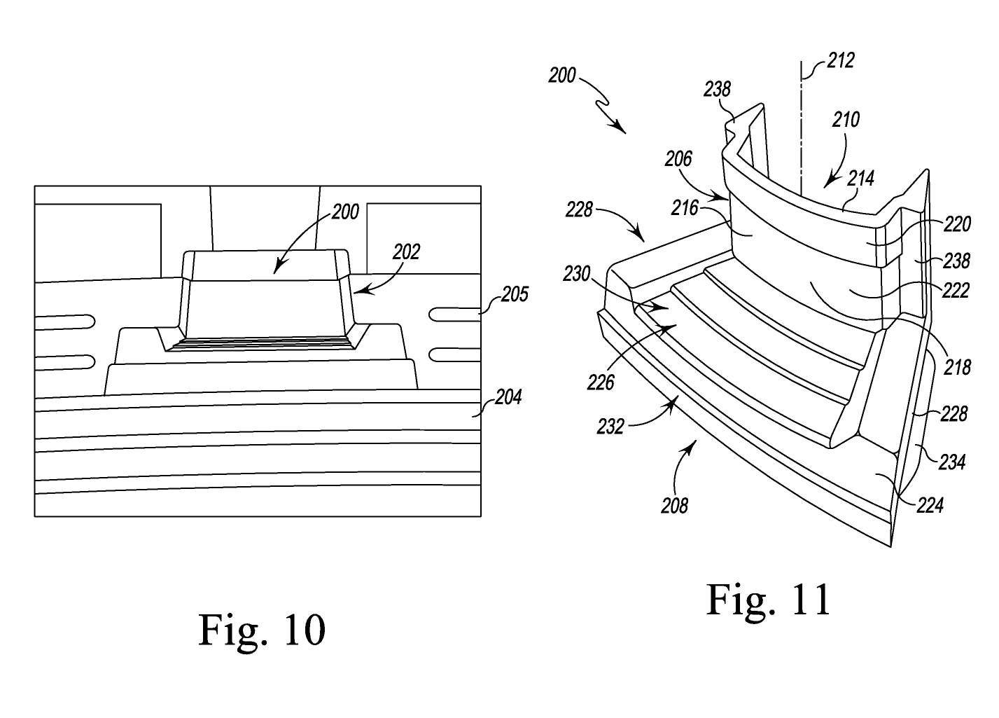

FIGS. 10-13 illustrate an alternative embodiment of an insert 200 that may be utilized to fill an opening 202 in an engine 204. Although insert 200 includes several features that differ from the insert 62, insert 200 likewise operates by applying a first force against the engine 204 and a second force against a fin 205 of the engine 204, wherein the first force is applied in a first direction and the second force is applied in a second direction that is opposite the first direction.

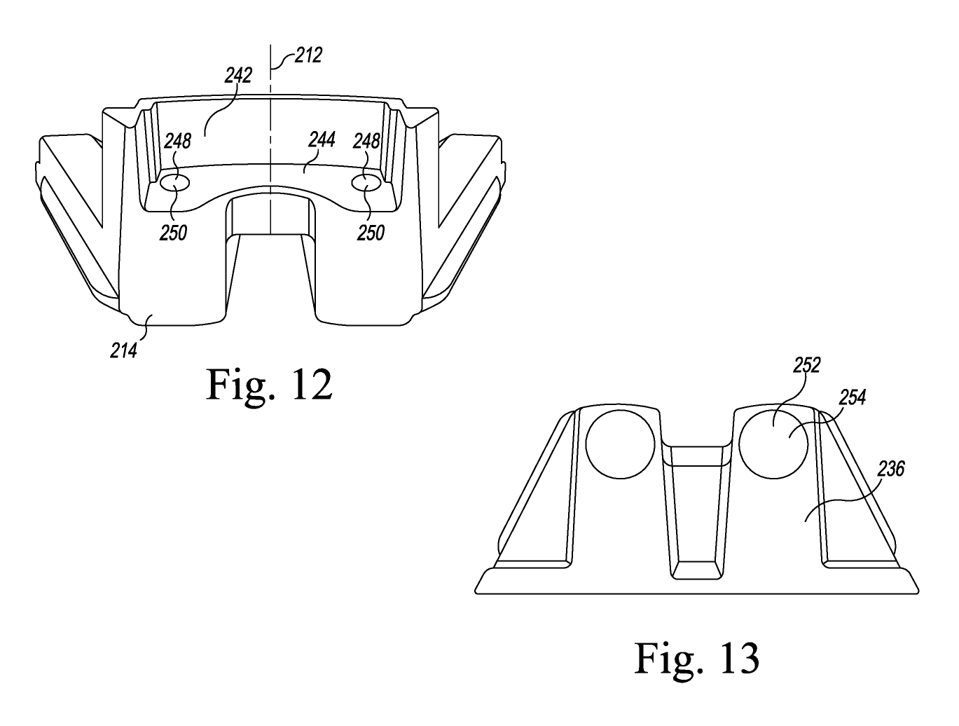

Referring to FIG. 11, the insert 200 includes an elongated body 206 extending between a lower end 208 and an upper end 210. A longitudinal axis 212 extends through the elongated body 206 from the lower end 208 to the upper end 210. The elongated body 206 includes an inner surface 214 that faces a spark plug and an outer surface 216 that faces outwardly from the engine 204. The outer surface 216 includes a decorative face 218. The decorative face 218 includes an upper face 220 and a lower face 222, wherein the upper face 220 extends outwardly with respect to the lower face 222. The outer surface 216 also includes a pair of decorative flanges 238 that are stepped inward from the decorative face 218 toward the inner surface 214.

A fin 224 is positioned proximate to the lower end 208 of the elongated body 206 and extends outwardly from the outer surface 216 of the elongated body 206. The fin 224 also includes a decorative finish that matches the decorative finish of the elongated body 206. The fin 224 includes an upper surface 226 and an outer surface 232 extending between a pair of side surfaces 228. The upper surface 226 includes a plurality of steps 230 defined thereon. The outer surface 232 likewise includes a step defined thereon. The fin 224 is generally wedge-shaped such that the side surfaces 228 flare outward from the elongated body 206 as the side surfaces 228 extend from the inner surface 214 to the outer surface 232 of the fin 224.

A flange 234 extends along each side surface 228 of the fin 224. The flange 234 is positioned at an intermediate position between the upper surface 226 of the fin 224 and a lower surface 236 (shown in FIG. 13) of the fin 224. The flange 234 extends between the inner surface 214 of the elongated body and the outer surface 232 of the fin 224. The flange 234 includes a flange surface 240 that is configured to engage the fin 205 of the engine 204.

Referring to FIG. 12, the inner surface 214 of the elongated body 206 includes a cavity 242 formed proximate to the upper end 210. The cavity 242 is at least partially defined by a surface 244 and a pair of sidewalls 246. A pair of bores 248 extends through the elongated body 206 and has upper openings 250 formed in the surface 244. Each upper opening 250 is positioned adjacent to a sidewall 246.

As illustrated in FIG. 13, the bores 248 include lower openings 252 formed in the lower surface 236. Each lower opening 252 includes a plug 254 positioned therein. Although not illustrated in FIGS. 10-13, the bores 248 also include threaded shafts positioned therein to actuate the plugs 254.

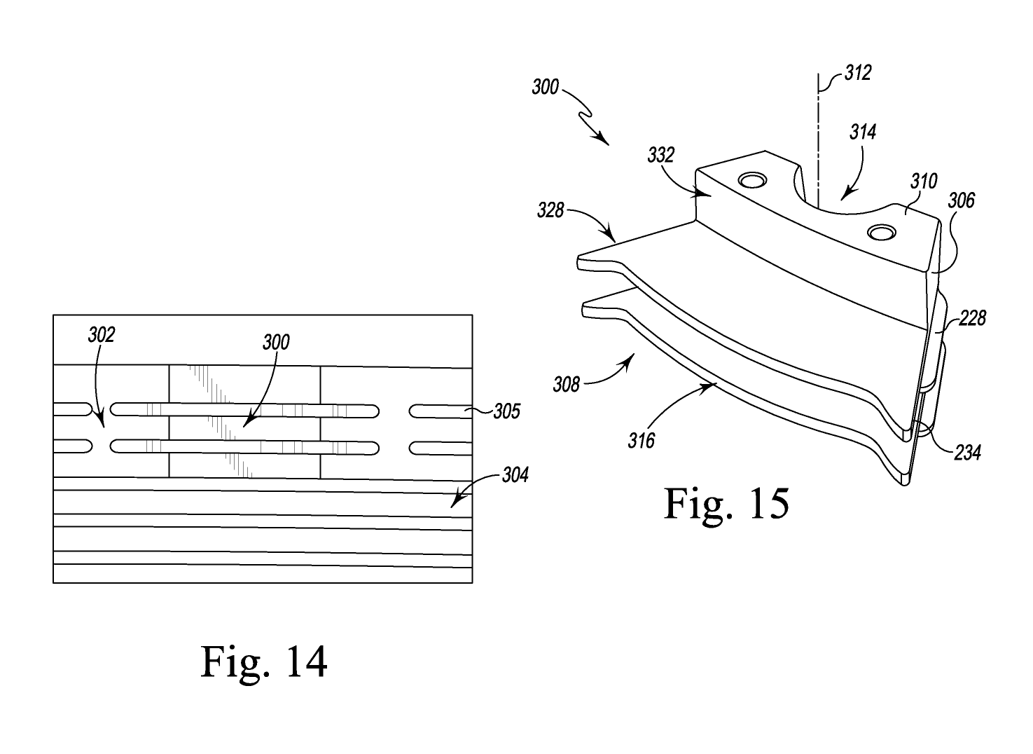

FIGS. 14-17 illustrate an alternative embodiment of an insert 300 that may be utilized to fill an opening 302 in an engine 304. Although insert 300 includes several features that differ from the insert 62, insert 300 likewise operates by applying a first force against the engine 304 and a second force against a fin 305 of the engine 304, wherein the first force is applied in a first direction and the second force is applied in a second direction that is opposite the first direction.

Referring to FIG. 15, the insert 300 includes an elongated body 306 extending between a lower end 308 and an upper end 310. A longitudinal axis 312 extends through the elongated body 306 from the lower end 308 to the upper end 310. The elongated body 306 includes an inner surface 314 that faces a spark plug and an outer surface 316 that faces outwardly from the engine 304.

A pair of fins 324 is positioned proximate to the lower end 308 of the elongated body 306 and extend outwardly from the outer surface 316 of the elongated body 306. The fins 324 include an outer surface 332 having a decorative finish that matches the decorative finish of the fin 305 of the engine 304. The fins 324 also include a pair of side surfaces 328. The fins 324 are generally wedge-shaped such that the side surfaces 328 flare outward from the elongated body 306 as the side surfaces 328 extend from the inner surface 314 of the elongated body 306 to the outer surface 332 of the fin 324. In the illustrated embodiment, the ends of the outer surface 332 of each fin 324 flare forward at the side surfaces 328. That is, the ends of the outer surface 332 have a “tooth-like” configuration.

A flange 334 extends from each fin 324. The flange 334 extends between the inner surface 314 of the elongated body 306 and the outer surface 332 of the fin 324. In the illustrated embodiment, each fin 324 includes an attachment body 360 extending below the outer surface 332 of the fin 324. The flange 334 extends outwardly from the attachment body 360 and the elongated body 306. The flange 334 includes a flange surface 340 that is configured to engage the fin 305 of the engine 304.

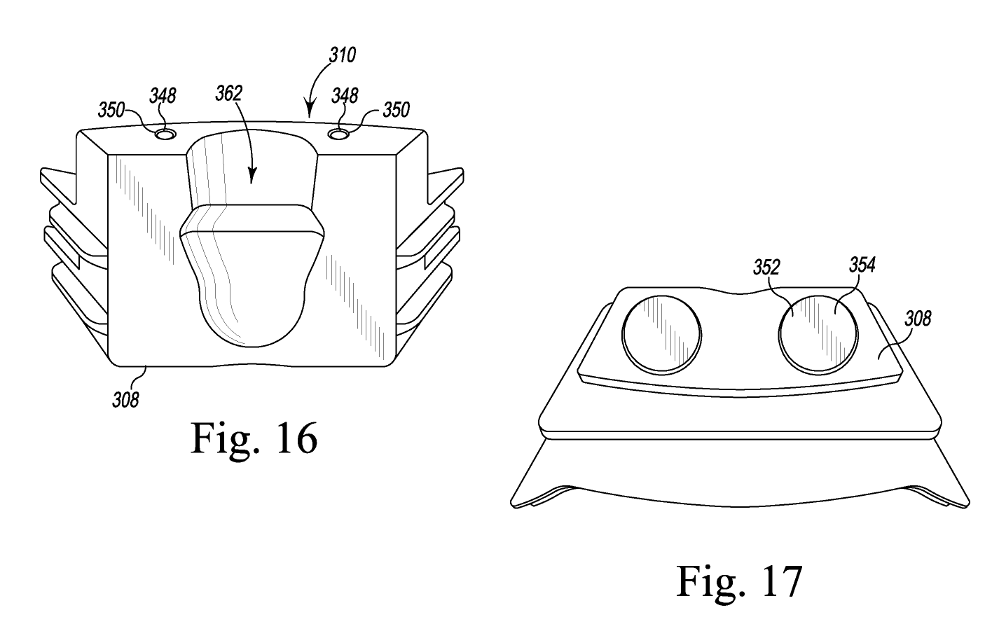

Referring to FIG. 16, the inner surface 314 of the elongated body 306 includes an indent 362 formed therein. The indent 362 extends along the inner surface 314 from the upper end 310 partially to the lower end 308 of the elongated body 306. The indent 362 may provide space for a spark plug behind the insert 300. Additionally or alternatively, the indent 362 may provide a position to grip the insert 300 to insert or remove the insert from the opening 302 of the engine 304.

A pair of bores 348 extend through the elongated body 306 and have upper openings 350 formed in the upper end 310. As illustrated in FIG. 17, the bores 348 include lower openings 352 formed in the lower end 308 of the elongated body 306. Each lower opening 352 includes a plug 354 positioned therein. Although not illustrated in FIGS. 14-17, the bores 348 also include threaded shafts positioned therein to actuate the plugs 354.

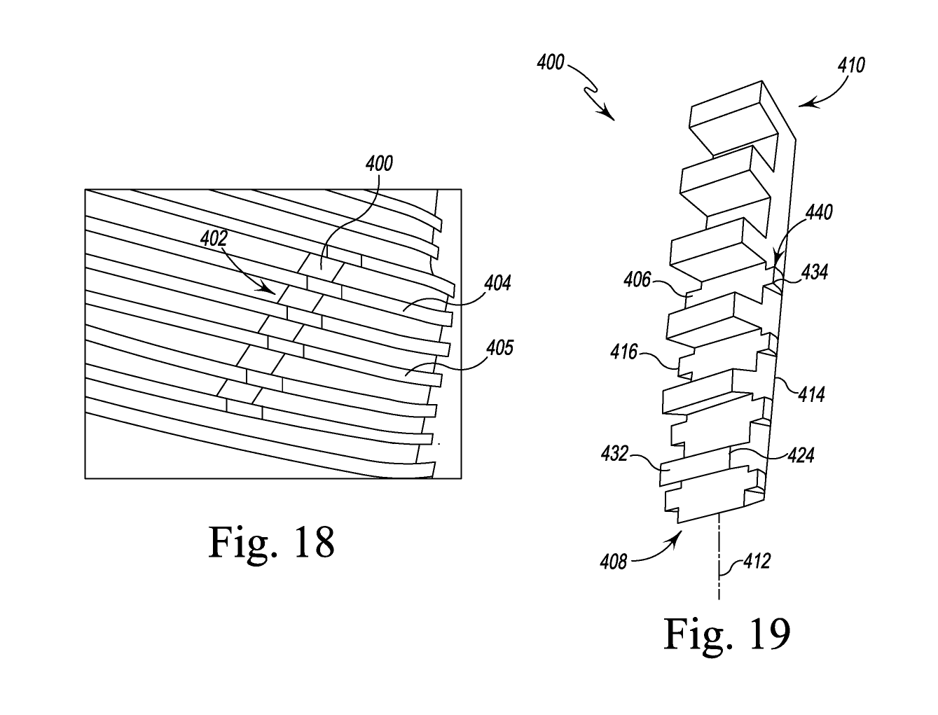

FIGS. 18-21 illustrate an alternative embodiment of an insert 400 that may be utilized to fill an opening 402 in an engine 404. Although insert 400 includes several features that differ from the insert 62, insert 400 likewise operates by applying a first force against the engine 404 and a second force against a fin 405 of the engine 404, wherein the first force is applied in a first direction and the second force is applied in a second direction that is opposite the first direction.

Referring to FIG. 19, the insert 400 includes an elongated body 406 extending between a lower end 408 and an upper end 410. A longitudinal axis 412 extends through the elongated body 406 from the lower end 408 to the upper end 410. The lower end 408 and the upper end 410 are angled with respect to the longitudinal axis 412. The elongated body 406 includes an inner surface 414 that faces the engine 404 and an outer surface 416 that faces outwardly from the engine 404.

A plurality of fins 424 extends outwardly from the outer surface 416 of the elongated body 406. The fins 424 include an outer surface 432 having a decorative finish that matches the decorative finish of the fin 405 of the engine 404. A plurality of flanges 434 extends outwardly from the elongated body 406. Each flange 434 is aligned with a space 435 defined between adjacent fins 424. The flanges 434 include a flange surface 440 that is configured to engage the fin 405 of the engine 404.

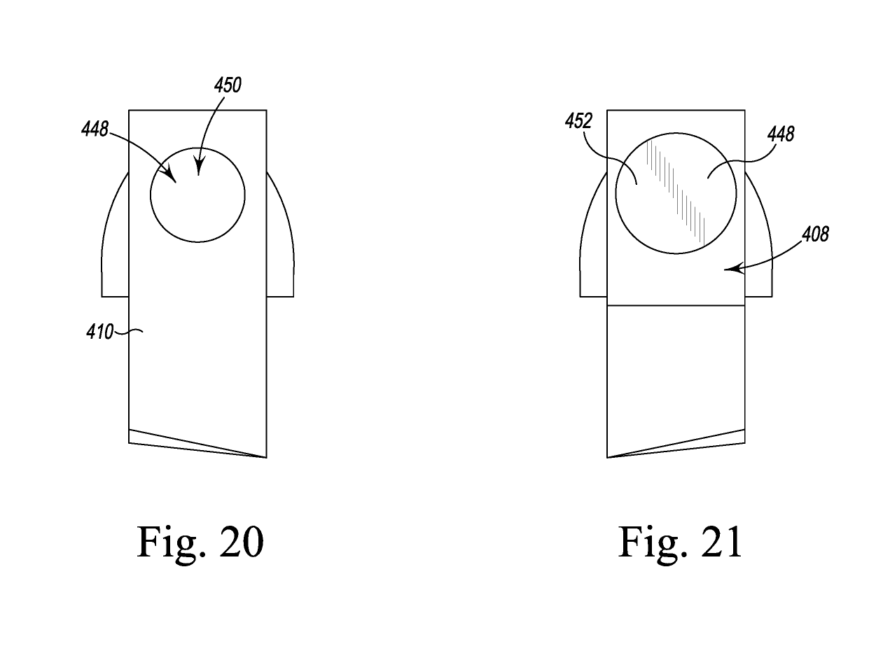

Referring to FIG. 20, a bore 448 extends through the elongated body 406 and has an upper opening 450 formed in the upper end 410. The bore 448 extends along the longitudinal axis 412 of the elongated body 406. As illustrated in FIG. 21, the bore 448 includes a lower opening 452 formed in the lower end 408 of the elongated body 406. Each lower opening 452 includes a plug 454 positioned therein. Although not illustrated in FIGS. 18-21, the bores 448 also include threaded shafts positioned therein to actuate the plugs 454.

The embodiments described above facilitate positioning an insert in an opening of an engine. It will be appreciated that the insert and methods described herein have broad applications. The foregoing embodiments were chosen and described in order to illustrate principles of the methods and apparatuses as well as some practical applications. The preceding description enables others skilled in the art to utilize methods and apparatuses in various embodiments and with various modifications as are suited to the particular use contemplated. In accordance with the provisions of the patent statutes, the principles and modes of operation of this disclosure have been explained and illustrated in exemplary embodiments.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

What is claimed is:

1. An apparatus comprising:
an insert for an engine comprising:
an elongated body sized to be positioned in an opening defined in the engine, the elongated body extending along a longitudinal axis from an upper end to a lower end,
a fin extending outwardly from the elongated body,
a flange extending outwardly from at least one of the fin and the elongated body, and
a locking mechanism coupled to the elongated body, the locking mechanism being moveable along the longitudinal axis between a first position in which the locking mechanism is positioned in the elongated body and a second position in which the locking mechanism extends outwardly from the lower end of the elongated body.

2. The apparatus of claim 1, wherein the insert further comprises a bore extending from the upper end to the lower end, the locking mechanism positioned in the bore.

3. The apparatus of claim 2, wherein the locking mechanism further comprises a threaded shaft positioned within the bore and operable to move a plug from the first position to the second position.

4. The apparatus of claim 3, wherein the bore includes an opening at the upper end of the elongated body, the threaded shaft accessible through the opening.

5. The apparatus of claim 1, wherein the fin includes side surfaces, the fin having a wedge shape such that the side surfaces angle away from the elongated body.

6. The apparatus of claim 1, wherein the fin includes an attachment body extending along a bottom surface thereof, the flange extending outwardly from the attachment body.

7. The apparatus of claim 1 further comprising a plurality of fins extending outwardly from the elongated body, wherein a fin proximal to the lower end of the elongated body is wider than a fin proximal to the upper end of the elongated body.

8. The apparatus of claim 1, wherein the elongated body includes an inner surface extending from the lower end to the upper end, the fin defining a passageway along the inner surface.

9. The apparatus of claim 1 further comprising an engine having an opening defined by a surface and a sidewall, the insert being positioned within the opening of the engine.

10. The apparatus of claim 9, wherein:
the engine includes a fin defining part of the sidewall of the opening, and
when the locking mechanism is in the second position and the insert is positioned in the opening, the locking mechanism applies a first force in a first direction to the surface of the engine and the flange of the insert applies a second force in a second direction to the fin of the engine, the first direction being opposite the second direction.

11. An insert for an engine comprising:
an elongated body sized to be positioned in an opening defined in the engine, the elongated body extending along a longitudinal axis from an upper end to a lower end, the elongated body having an inner surface and an outer surface,
a fin extending outwardly from the outer surface of the elongated body,
a flange extending outwardly from the fin, and
a locking mechanism coupled to the elongated body, the locking mechanism being moveable along the longitudinal axis between a first position in which the locking mechanism is positioned in the elongated body and a second position in which the locking mechanism extends outwardly from the lower end of the elongated body.

12. The insert of claim 11, further comprising:
a bore extending along the longitudinal axis from the upper end to the lower end, the locking mechanism positioned in the bore, wherein the bore includes an opening at the upper end of the elongated body, the locking mechanism accessible through the opening.

13. The insert of claim 11, wherein the fin includes side surfaces, the fin having a wedge shape such that the side surfaces angle away from the elongated body.

14. The insert of claim 11, wherein the fin includes an attachment body extending along a bottom surface thereof, the flange extending outwardly from the attachment body.

15. The insert of claim 11 further comprising a plurality of fins extending outwardly from the elongated body, wherein a fin proximal to the lower end of the elongated body is wider than a fin proximal to the upper end of the elongated body.

16. The insert of claim 11, wherein the fin defines a passageway along the inner surface.

17. A method comprising:
aligning an insert with an opening defined in an engine,
advancing the insert into the opening to position a flange of the insert below a fin of the engine, and
actuating a moveable locking mechanism of the insert to advance the locking mechanism in a first direction to apply a first force to a surface of the engine and move the flange of the insert in a second direction to apply a second force to the fin of the engine, wherein the first direction is opposite the second direction.

18. The method of claim 17 further comprising operating a threaded shaft to move the locking mechanism of the insert in the first direction.

19. The method of claim 17 wherein actuating the locking mechanism further comprises moving a plurality of flanges of the insert in the second direction to apply a plurality of second forces to a plurality of fins of the engine, a sum of the magnitude of the plurality of second forces being equal to the magnitude of the first force.

20. The method of claim 17, wherein advancing the insert into the opening to position a flange of the insert below a fin of the engine further comprising positioning the flange of the insert in a slot of the engine.
